(19) United States
(12) Patent Application Publication
(10) Pub. No.: US 2010/0153497 A1
(43) Pub. Date: Jun. 17, 2010

(54) SHARING EXPRESSION INFORMATION AMONG CONFERENCE PARTICIPANTS

(75) Inventors: Dany Sylvain, Gatineau (CA); Nicholas Sauriol, Kanata (CA)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 12/334,202

(22) Filed: Dec. 12, 2008

(51) Int. Cl. G06F 17/30

(52) U.S. Cl. 709/204

(57) ABSTRACT

Participants in a conference are associated with communication terminals, each of which including an expression client that is configured to interact with an expression control function. When a first participant desires to share expression information, the first participant may select expression information representing a desired expression via a first expression client provided by the first participant's communication terminal. The first expression client will provide a corresponding expression request to the expression control function, which will process the expression request and provide an expression instruction to one or more of the expression clients of the participants.

### FIELD OF THE INVENTION

The present invention relates to communication, and in particular to sharing expression information among conference participants.

### BACKGROUND OF THE INVENTION

Audio and video conferencing generally lack the ability to exchange most, if not all, non-verbal communications that normally occur during face-to-face communications. Non-verbal communications generally include body language, facial expressions, hand gestures, and the like. Significant information and context for verbal communications is generally carried in the associated non-verbal communications, which are available to parties who communicate in person. In many instances, these subtle cues of non-verbal communications carry significant meaning.

With audio conferencing, practically all non-verbal communications are lost, and video conferencing is not much better. With video conferencing, the quality of the image is often low, and the video provided to the conference participants at any given time is either focused on the active speaker or focused on a larger area that includes one or more conference participants. When focused on the active speaker, the non-verbal communications of the other participants are lost, and when focused on a larger area, there is little opportunity to convey the subtleties of the non-verbal communications given the relatively limited resolution and size of the video image.

The cues associated with non-verbal communications may be unintentional or intentional. Intentional cues are often used to minimize the potential for interrupting an active speaker or the overall conference in general. For example, cues for approval or disapproval may include moving one's head in a respective manner. Shrugging one's shoulders or a look of confusion or frustration may signal indifference, frustration, or a lack of understanding, respectively. Raising one's hand may signify a question or an attempt to gain the attention of active or non-active conference participants. Certain other hand gestures may be used to encourage a speaker to slow down, speed up, get to the point, or provide requested feedback. The types of cues and the information that may be conveyed with such cues are virtually limitless, and will vary in context.

In most conferencing environments where two or more parties are in different locations, most if not all of these non-verbal communications are either lost or significantly diminished. As such, there is a need for an efficient and effective way to share non-verbal communications among two or more participants in a conference call, wherein at least two participants are in different locations at any given time. There is a further need to facilitate such non-verbal communications for participants that are in the same location in an effort to minimize the impact of such non-verbal communications on the overall conference or provide more effective communication of non-verbal information.

### SUMMARY OF THE INVENTION

The present invention relates to allowing participants in a conference, such as a telephone call or conference call, to share non-verbal expression information with one another in an effective and efficient manner. The participants are associated with communication terminals. Each communication terminal has an expression client that is configured to interact with an expression control function, which is capable of facilitating the sharing of expression information between the expression clients. In general, when a first participant desires to share expression information, the first participant may select expression information representing a desired expression via a first expression client provided by the first participant's communication terminal. The first expression client will provide a corresponding expression request to the expression control function, which will process the expression request and provide an expression instruction to one or more of the expression clients of the participants. The expression instruction instructs the expression clients to present the expression information representing the desired expression to the participants in a manner indicating that the expression information was requested by the first participant. As such, the non-verbal expression information can be selected by one participant and provided to other participants in a dynamic fashion in association with the voice session.

In one embodiment, the expression information takes the form of an expression object, such as an emoticon or like indicator that can readily convey a non-verbal expression of one participant when presented to another participant. An expression object may take virtually any form, such as but not limited to text, a symbol, an icon, an image, a static graphic, an animated graphic, a video segment, an expression photo of the participant, a gesture of the participant avatar in a 3D virtual environment, or any combination thereof. Potential expression objects may be maintained in an expression dictionary. The expression objects may cover a wide range of non-verbal expressions that connote expressions including, but not limited to happiness, approval, disapproval, anger, sadness, acceptance, rejection, confusion, boredom, misunderstanding, and the like. The expression objects that are available for use may be pre-defined or customized by a conference participant or administrator entity. Different groups of expression objects may be allocated for different situations and defined in the expression dictionary. For example, different groups of expression objects may be pre-defined for business, personal, and gaming settings. Within a given setting, sub-groups of expression objects may be defined. A business setting may provide a first group of expression objects for management meetings, a second group of expression objects for collaboration meetings, and a third group of expression objects for information disseminations. Different groups may include common expression objects, but may have at least one different expression object. Alternatively, a meeting conference organizer may select desirable expression objects from a comprehensive list of expression objects to form customized group of expression objects for a specific conference. Accordingly, the expression objects available to participants may vary from one call to another.

The expression control function may control the group of expression objects that are available to the participants by providing the expression objects of the group to the expression clients for each of the participants. All or select expression objects may be downloaded to the expression clients substantially permanently, or dynamically based on what expression objects are needed for a given conference call, participant, or the like, preferably under the control of the expression control function. In addition to dynamically receiving expression requests from expression clients to assert expression objects and providing instructions to the expression clients to present the corresponding expression objects, the expression control function may also control if, when, and for how long expression objects that are request by a first participant should be presented to the other participants based on expression rules.

The expression control function may also maintain the status of expression objects that are being shared at any given time as well as an historical record of such sharing. Further, the expression control function may maintain a list of participants in a given conference and provide the list of participants to each of the expression clients for the participants in the conference. Each expression client may display the list of participants to the corresponding participant. When an expression object is requested by a first participant, the expression control function may instruct each of the expression clients to display the expression object in a manner indicating that the expression object was requested by the first participant.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a conference environment according to one embodiment of the present invention.

FIGS. 2A and 2B illustrate expression windows according to one embodiment of the present invention.

FIG. 3 is a block representation of an alternative conference environment according to one embodiment of the present invention.

FIGS. 4A and 4B are a communication flow illustrating a click-to-call conference access scenario according to one embodiment of the present invention.

FIG. 5 illustrates a meeting notice according to one embodiment of the present invention.

FIG. 6 illustrates a click-to-call page according to one embodiment of the present invention.

FIGS. 7-17 illustrate a sequence of conference media pages that illustrate expression sharing according to one embodiment of the present invention.

FIG. 18 is a block representation of an audio bridge according to one embodiment of the present invention.

FIG. 19 is a block representation of a service node configured according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention relates to allowing participants in a conference, such as a telephone call or conference call, to share non-verbal expression information with one another in an effective and efficient manner. The participants are associated with communication terminals. Each communication terminal can be associated with an expression client that is configured to interact with an expression control function, which is capable of facilitating the sharing of expression information between the expression clients. In general, when a first participant desires to share expression information, the first participant may select expression information representing a desired expression via a first expression client associated with the first participant's communication terminal. The first expression client will provide a corresponding expression request to the expression control function, which will process the expression request and provide an expression instruction to one or more of the expression clients of the participants. The expression instruction instructs the expression clients to present the expression information representing the desired expression to the participants in a manner indicating that the expression information was requested by the first participant. As such, the non-verbal expression information can be selected by one participant and provided to other participants in a dynamic fashion in association with the voice session.

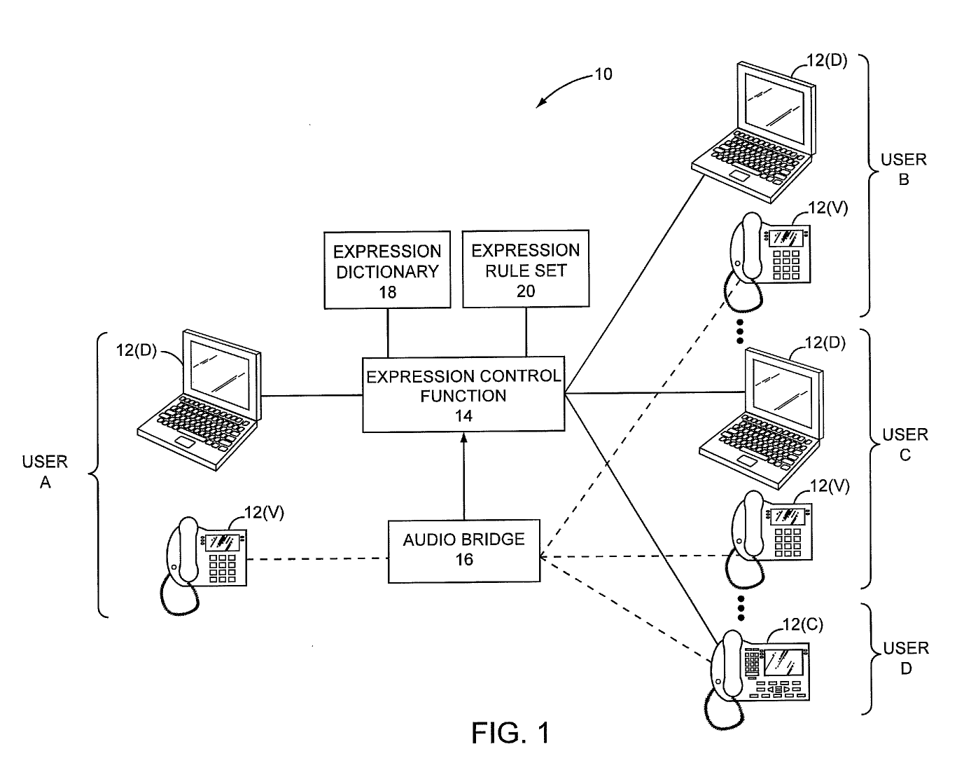

Prior to delving into the details of the present invention, an overview of an exemplary conference environment 10 is illustrated in association with FIG. 1. As illustrated, a number of communication terminals 12 are in communication with either or both an expression control function 14 and an audio bridge 16, which is capable of providing a conferencing function for multiple voice sessions, or calls. The communication terminals are generally referenced with the numeral 12; however, the different types of communication terminals are specifically identified when desired with a letter V, D, or C. In particular, a voice communication terminal 12(V) is primarily configured for voice communications, is capable of establishing voice sessions with the audio bridge 16 through an appropriate voice network, and generally has limited data processing capability. The voice communication terminal 12(V) may represent a wired, wireless, or cellular telephone or the like, while the voice network may be a cellular or public switched telephone network (PSTN).

A data communication terminal 12(D) may represent a computer, personal digital assistant, media player, or like processing device that is capable of communicating with the expression control function 14 conference system 14 over a data network, such as a local area network, the Internet, or the like. In certain embodiments, certain users will have a data communication terminal 12(D) for communicating with the expression control function 14 to facilitate sharing of expression information and an associated voice communication terminal 12(V) to support a voice session with the audio bridge 16 for a conference call. For example, a user may have an office or cellular telephone for the voice session as well as a personal computer for sharing expression information in association with the conference call. Alternatively, a composite communication terminal 12(C) may support a voice session with the audio bridge 16 as well as communications with the expression control function 14 to facilitate the sharing of expression information. The composite communication terminal 12(C) may be a personal computer that is capable of supporting telephony applications, a telephone capable of supporting computing applications, such as a browser application, or the like.

In certain embodiments of the present invention, certain conference participants are either associated with a composite communication terminal 12(C) or both voice and data communication terminals 120, 12(D). As illustrated, Users A, B, and C are associated with both voice and data communication terminals 12(V), 12(D) while User D is associated with a composite communication terminal 12(C). Notably, users that are engaged in a conference call or expression sharing session are referred to as participants. For a conference call, each participant is engaged in a voice session, or call, which is connected to the audio bridge 16. The communication terminals 12, such as the composite communication terminal 12(C) and the data communication terminals 12(D) that are capable of communicating with the expression control function 14 may have an expression client (not illustrated). Each expression client is capable of communicating with the expression control function 14 and providing the expression sharing functionality for the composite and data communication terminals 12(C) and 12(D). An expression client may be provided in a separate application or may be integrated with one or more applications running on the composite and data communication terminals 12(C) and 12(D).

In one embodiment, the expression information that is shared among participants takes the form of an expression object, such as an emoticon or like indicator that can readily convey a non-verbal expression of one participant when presented to another participant. An expression object may take virtually any form, such as but not limited to text, a symbol, an icon, an image, a static graphic, an animated graphic, a video segment, an expression photo of the participant, a gesture of the participant avatar in a 3D virtual environment, or any combination thereof. Potential expression objects may be maintained in an expression dictionary 18, which is provided in or is accessible by the expression control function 14. The expression objects may cover a wide range of non-verbal expressions that connote expressions including, but not limited to happiness, approval, disapproval, anger, sadness, acceptance, rejection, confusion, boredom, misunderstanding, and the like. The expression objects that are available for use may be pre-defined or customized by a conference participant or administrator entity. For example, instead of general emoticons used by everyone, a participant may choose his preferred emoticons for specific expressions or use photos of himself expressing those expressions.

Different groups of expression objects may be allocated for different situations and defined in the expression dictionary 18. For example, different groups of expression objects may be pre-defined for business, personal, and gaming settings. Within a given setting, sub-groups of expression objects may be defined. A business setting may provide a first group of expression objects for management meetings, a second group of expression objects for collaboration meetings, and a third group of expression objects for information disseminations. Alternatively, a meeting conference organizer may select desirable expression objects from a comprehensive list of expression objects to form a customized group of expression objects for a specific conference. Notably, the expression objects available to participants may vary from one call to another. The expression control function 14 may control the group of expression objects that is available to the participants by providing the expression objects of the group to the expression clients for each of the participants. All or select expression objects may be downloaded to the expression clients substantially permanently or dynamically based on what expression objects are needed for a given conference call, participant, or the like, preferably by or under the control of the expression control function 14.

In operation, an expression client will present the group of expression objects that is available for a conference call to the participant. When asserting an expression, an expression client will allow a participant to select an expression object from the group of expression objects and provide to the expression control function 14 a corresponding expression request that identifies the expression object being asserted by the participant. The expression control function 14 will process the expression request and provide expression instructions that identify the expression object being asserted and the participant who is asserting the expression object to the expression clients of one or more of the other participants.

The expression instructions effectively instruct the expression clients to present the expression object representing the desired expression to the participants in a manner indicating that the expression object was requested by the participant who is asserting the expression object. Upon receiving from the expression control function 14 an expression instruction to display an expression object that is being asserted by another participant, the expression client will display the expression object being asserted by the other participant. Preferably, the expression client will display an expression object being asserted by a given participant to other participants in a manner indicating that the expression object is being asserted by the given participant. As such, participants to the conference call can readily associate an expression object with the participant who asserted the expression object.

In addition to dynamically receiving expression requests from expression clients to assert expression objects and providing instructions to the expression clients to present the corresponding expression objects, the expression control function 14 may also control if, when, and for how long expression objects that are requested by a first participant should be presented to the other participants based on expression rules, which may be set by the participant or maintained in an expression rule set 20 that is integrated in or accessible by the expression control function 14 or set by the participant. For example, a participant or the expression rule set 20 may dictate that, once asserted and displayed, a given expression object will be:
displayed indefinitely until removed or changed by the participant;
displayed for a defined period of time, such as thirty (30) seconds;
displayed until cleared by the conference organizer, chairperson, active speaker, identified participant, or the like; or
displayed until the participant who asserted (is associated with) the expression object becomes the active speaker in the conference session.

The expression control function 14 may also maintain the current status of expression objects that are being shared at any given time as well as an historical record of such sharing. Further, the expression control function 14 may maintain a list of participants in a given conference call and provide the list of participants to each of the expression clients for the participants in the conference call.

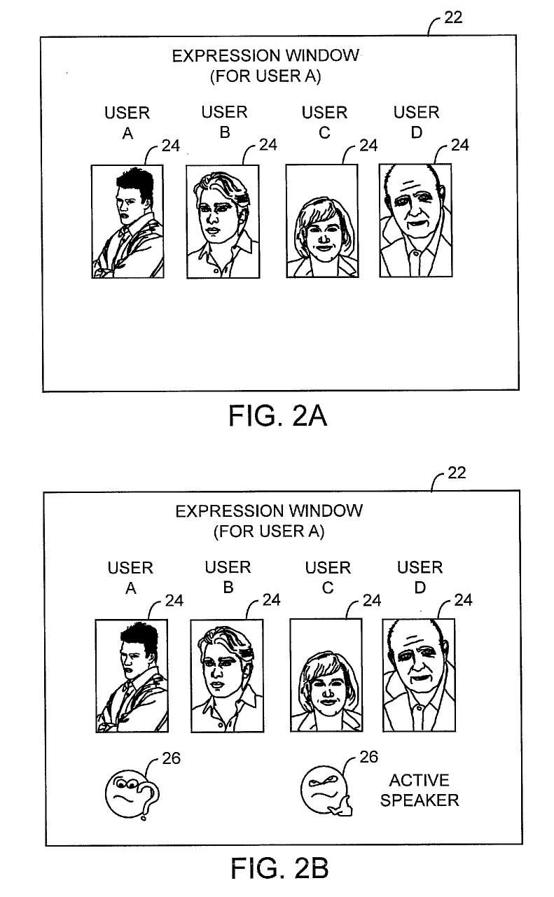

With reference to FIG. 2A, the expression client for a given communication terminal 12 may present an expression window 22 to a participant. In the illustrated embodiment, the expression window 22 may initially include participant objects 24, which represent text, a symbol, an icon, an image, a static graphic, an animated graphic, a video segment, or any combination thereof that provides a unique identifier for a given conference participant. In essence, the participant object 24 is a visual indicator used to identify the various participants in a conference call. An expression window 22 may include participant objects for each of the participants in the conference call, or only for those participants that are capable of sharing expressions. Further, the expression window 22 may or may not include a participant object 24 for the participant associated with the expression client providing the expression window 22. In this example, the expression window 22 is the expression window for User A, and participant objects 24 are provided in the expression window 22 for users A, B, C, and D. The expression window 22 of FIG. 2A represents an expression window 22 that is shown when no expression objects are being asserted or displayed.

The expression window 22 in FIG. 2B illustrates an exemplary technique for presenting and displaying expression objects in association with the corresponding participants (users A, B, C, and D). As depicted, emoticons 26 are presented in association with users A and C. Since the expression window 22 is associated with User A, the emoticon presented in association with User A is indicative of User A having asserted the associated emoticon 26. The emoticon 26 that was asserted by User A indicates that User A is asserting a non-verbal communication that is indicative of User A having a question, hence the “question” emoticon 26. The emoticon 26 associated with User C is indicative of User C having asserted an expression object, which is represented as the emoticon 26 associated with User C. The emoticon 26 associated with User C indicates that User C is asserting a non-verbal communication indicative of confusion, hence the “confusion” emoticon 26. Accordingly, the expression window 22 may identify the participants in a conference session, as well as keep track of expression objects being asserted by the participant associated with the expression window 22 as well as display expression objects asserted by other participants. The expression client will communicate with the expression control function 14 to facilitate such functionality. The expression control function 14 will maintain the status of the expression objects, and instruct the expression clients to present, clear, or otherwise control the display of expression objects and participant objects 24. Preferably, the expression control function 14 is capable of communicating with the audio bridge 16 or other conference control entity to identify the participants in the associated conference call, as well as determine when new participants join the conference call or when participants leave the conference call. The participant objects 24 may be updated accordingly by the expression clients in response to corresponding instructions by the expression control function 14.

In certain embodiment, the audio bridge 16 is capable of identifying one or more participants that are currently actively speaking at any given time, and providing this information to the expression control function 14. In response, the expression control function 14 may identify the participant or participants who are actively speaking at any given time in the expression window 22. In FIG. 2B, User D is identified as an active speaker. The active speaker designation will change as different participants start and stop speaking throughout the conference call. In addition to designating the active speaker in the expression window 22 of the expression client, the expression control function 14 may use the active speaker information to control if, when, and how expression objects are to be presented in the expression windows 22 based on additional rules provided in the expression rule set 20. For example, certain expression objects may not be asserted when certain participants are speaking, or the display of an expression object asserted by a first user may be cleared upon the first user becoming the active speaker. In the latter case, there is an assumption that the expression represented by the expression object being asserted will be addressed by the participant once they become the active speaker. In another embodiment, the expression window may be substituted with other expression methods. For example, if the primary user interface is a 3D virtual environment such as the ones used in video games, the expressions may be rendered in the 3D environment as gestures of the avatar's participant in the 3D environment or as objects showing up in the 3D environment and associated with the participant avatar, such as a floating question mark over the avatar.

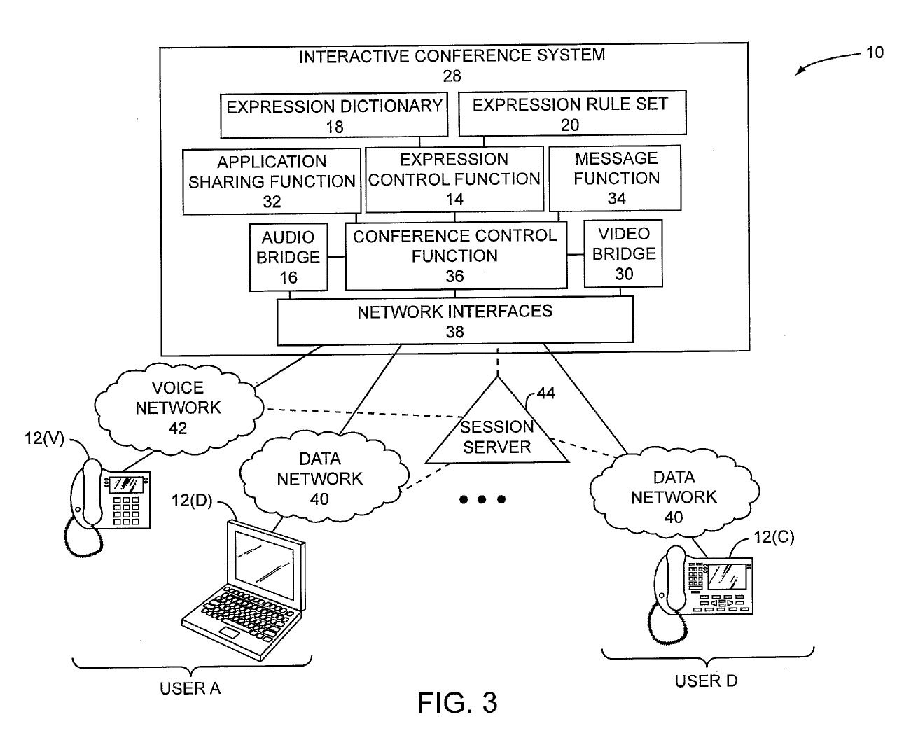

Another embodiment of the present invention is illustrated in FIG. 3. As illustrated, a number of communication terminals 12 are in communication with an interactive conference system 28, which may have one or more of the following: the audio bridge 16, the expression control function 14, the expression dictionary 18, and the expression rule set 20, as well as a video bridge 30, an application sharing function 32, and a messaging function 34. A conference control function 36 is provided to control the overall interactive conference system 28 and the various functions provided thereby. One or more network interfaces 38 facilitate communications with the various communication terminals 12 through data and voice networks 40, 42. As illustrated, User A is associated with both voice and data communication terminals 12(V), 12(D) while User D is associated with the composite communication terminal 12(C). The voice communication terminal 12(V) is supported by the voice network 42 while the data and composite communication terminals 12(D) and 12(C) are supported by the data network 40.

Within the interactive conference system 28, the expression control function 14 and associated expression dictionary 18 and expression rule set 20, as well as the audio bridge 16 operate substantially as described above. The video bridge 30 may facilitate video conferencing among the various participants via the associated data communication terminals 12(D) or composite communication terminals 12(C). The application sharing function 32 allows the various participants to share applications, wherein a document or application interface being viewed by one participant may also be viewed by the other participants. Further, control of the application may be allocated to different participants or change from one participant to another. During the conference, different participants may activate different applications and share the content of those applications with the other participants. An exemplary application sharing function 32 may support Microsoft® Live Meeting or like applications. When applications are being shared, corresponding applications on the data or composite communication terminals 12(D) or 12(C) will cooperate with the application sharing function 32 to support the application sharing functionality. Notably, an application sharing client may be provided with or in association with the expression client, such that application sharing and expression sharing can take place from a common window that is presented to the different participants. Similarly, the messaging function 34 may facilitate various types of messaging between the participants during a conference call. The messaging may include instant messaging, email, or the like. The messaging may be facilitated at the various data or composite communication terminals 12(D) or 12(C), in a separate application or in conjunction with the expression client. In one embodiment, overall control of the interactive conference system 28 is provided by a conference control function 36, which cooperates with the various entities of the interactive conference system 28 to provide an integrated conference experience for the various participants. Accordingly, application sharing, expression sharing, messaging, conference video, or any combination thereof may be presented to the participants via the data or composite communication terminals 12(D) or 12(C) via separate or composite clients, as will be described in further detail below.

In one embodiment of the present invention, the conference control function 36 is capable of interacting with a session server 44 to facilitate establishment of voice sessions between the appropriate communication terminals 12 and the audio bridge 16 in an efficient and automated manner. In particular, participants are allowed to initiate voice sessions with the audio bridge 16 through a browser or like application interface, which will provide instructions to the conference control function 36 to initiate a voice session between the participant's voice communication terminal 12(V) or composite terminal 12(C). The conference control function 36 will cooperate with the audio bridge 16 and the session server 44 to facilitate a voice session between the voice communication terminal 12(V) or the composite communication terminal 12(C) and the audio bridge 16.

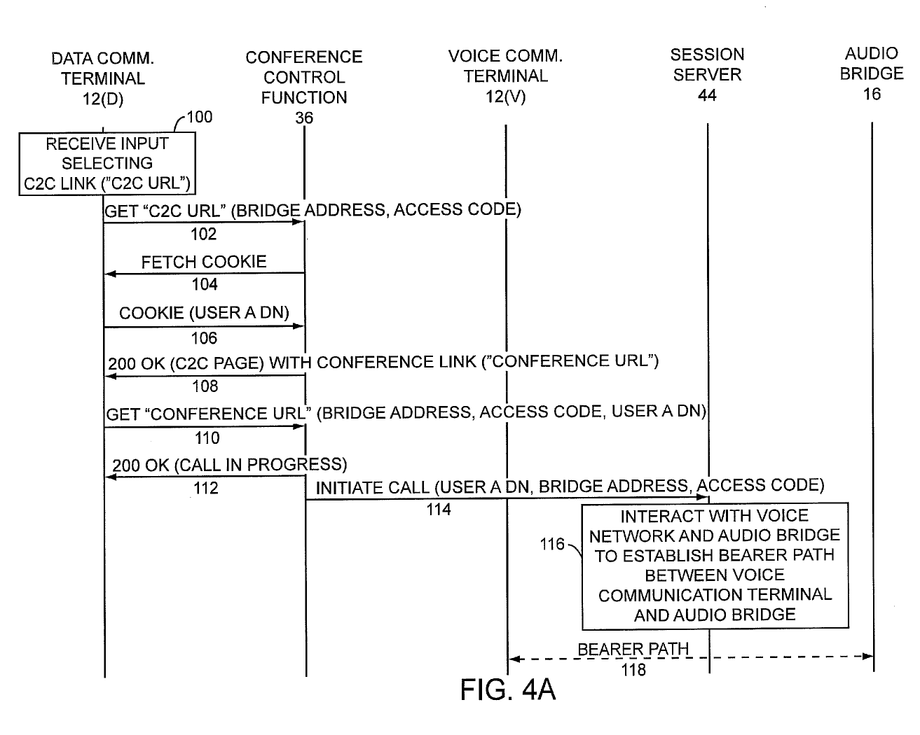

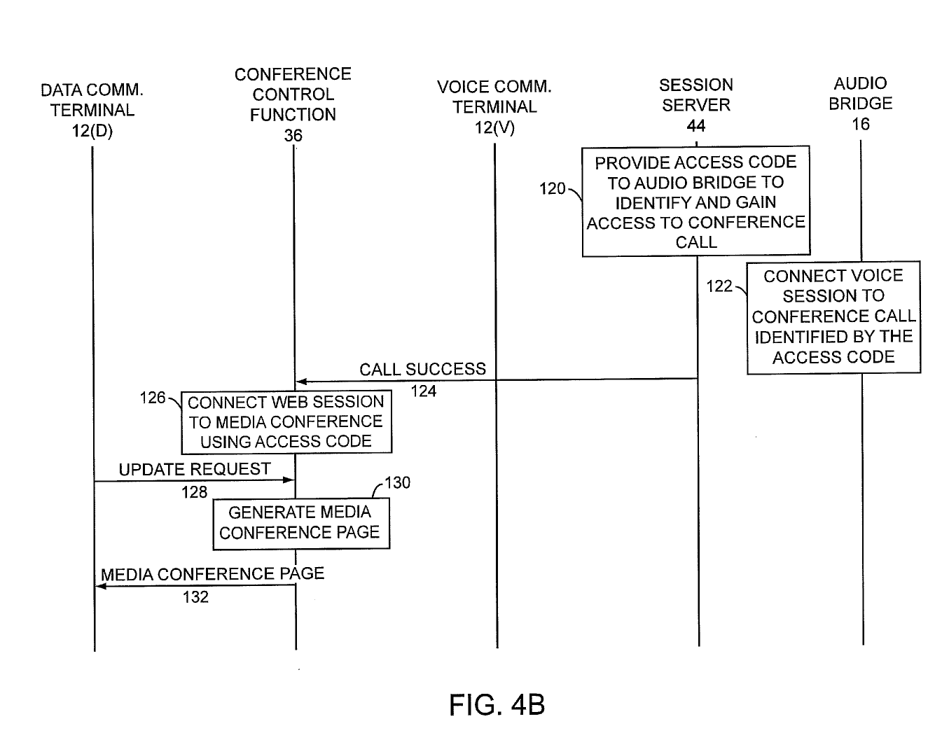

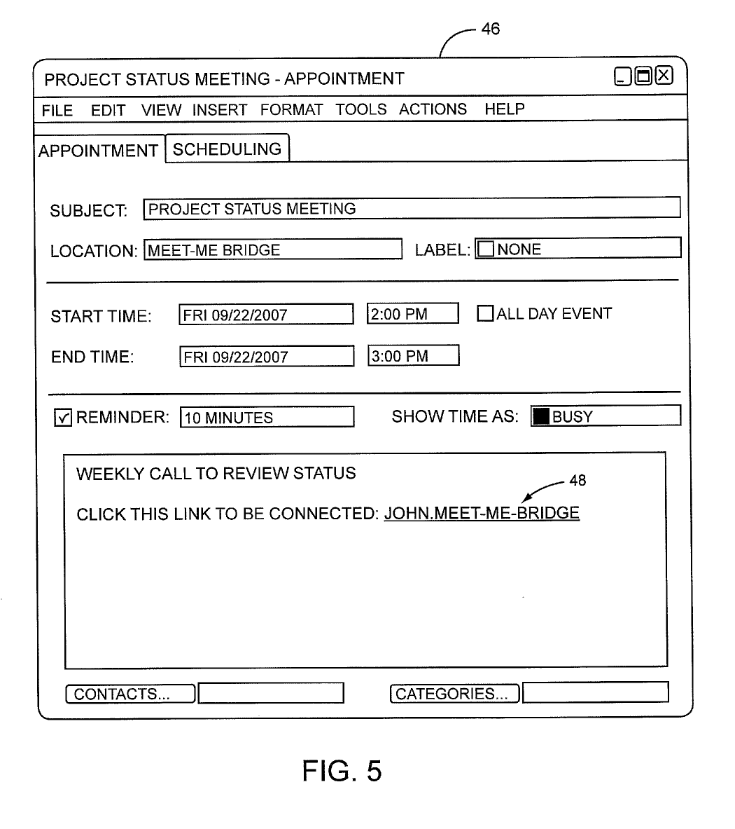

Turning now to FIGS. 4A and 4B, a communication flow is provided to illustrate how a conference participant associated with the data communication terminal 12(D) and the voice communication terminal 12(V) can join a conference call hosted by the audio bridge 16 and then share non-verbal expressions through corresponding expression objects according to one embodiment of the present invention. Although the communication flow illustrates the use of click-to-call techniques to establish a voice session between a voice communication terminal 12(V) and the audio bridge 16, establishment of the voice session may take place in traditional fashion. Assume that User A who is associated with the voice and data communication terminals 12(V) and 12(D) desires to join a multimedia conference session, which includes audio, video, expression sharing, and messaging components. Further assume that the conference call was scheduled though a calendar invite 46 or like meeting notice, such as the one illustrated in FIG. 5. The calendar invite 46 is supported by a calendar application running on the data communication terminal 12(D). The calendar invite 46 may include a “click-to-call” (C2C) link 48 that is associated with a C2C uniform resource locator (URL), which points to the conference control function 36. The C2C link 48 is textually labeled “John.meet-me-bridge.” The C2C link 48 is also associated with a bridge address for the audio bridge 16 and an access code identifying the conference call that the conference participant will join.

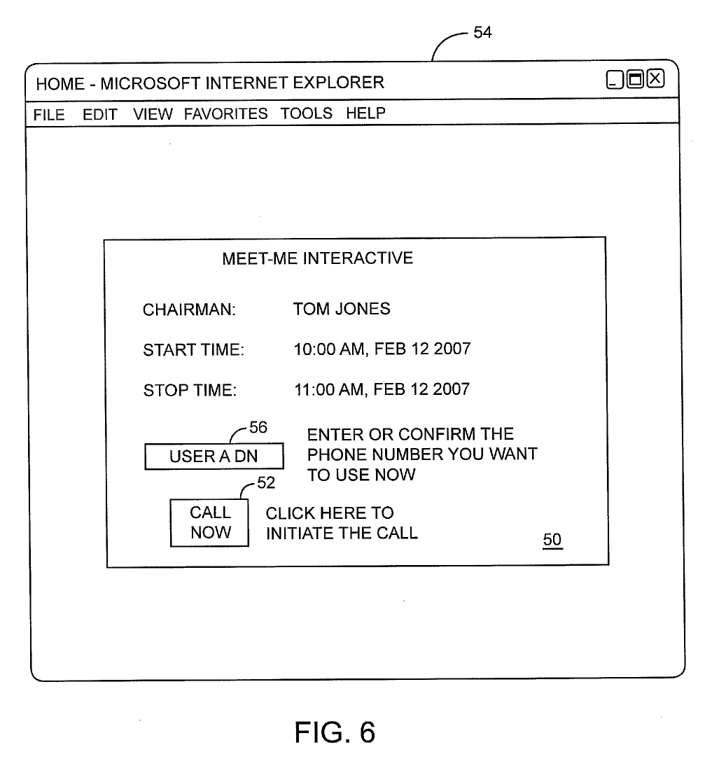

When the C2C link 48 is selected by the conference participant (step 100), the data communication terminal 12(D) will open a browser or like application and send an HTTP Get message to the conference control function 36 using the C2C URL associated with the conference control function 36, along with the bridge address for the audio bridge 16 and the access code for the conference call (step 102). The conference control function 36 may respond by fetching an existing browser cookie or like information already containing the directory number or address corresponding to the voice communication terminal 12(V) to be associated with the data communication terminal 12(D). As such, the conference control function 36 will send a message to fetch the cookie to the data communication terminal 12(D) (step 104), which will respond with cookie information identifying the directory number (USER A DN) for the voice communication terminal 12(V) (step 106). The conference control function 36 may then create a C2C page with a conference link (“Call Now”) that is associated with a conference URL, and send the C2C page to the data communication terminal 12(D) in a 200 OK message (step 108). An exemplary C2C page 50 is illustrated in FIG. 6. The data communication terminal 12(D) may display the C2C page 50 with a “Call Now” conference link 52 in a browser interface 54 or other appropriate application interface to User A, as illustrated in FIG. 6. The C2C page 50 may include an address field 56 that is used to identify an address, such as a DN, that is associated with the voice communication terminal 12(V) to be used for the conference call. If a cookie was used to obtain User A's DN (User A DN) as described above, the C2C page 50 may already include User A's DN in an appropriate address field 56 for the user to confirm. If a cookie wasn't available or the DN provided in the address field 56 is not the desired one, User A may enter a DN or other address, which is associated with the voice communication terminal 12(V) to use for the conference call in the address field 56.

Once the conference link 52 is selected, the data communication terminal 12(D) will send an HTTP Get message to the conference control function 36 using the “Conference URL” (step 110). The HTTP Get message may include the bridge address for the audio bridge 16, the access code, and the directory number for the voice communication terminal 12(V). The conference control function 36 will respond to the data communication terminal 12(D) with a 200 OK message indicating that a call into the audio bridge 16 is in progress (step 112), and the page displayed by the browser interface 54 may be updated accordingly (not shown). The conference control function 36 will then provide an Initiate Call message to the session server 44 to initiate a call between the voice communication terminal 12(V) and the audio bridge 16 (step 114). The Initiate Call message will include the directory number (USER A DN) for the voice communication terminal 12(V) and the bridge address for the audio bridge 16 for the session server 44 to use in establishing the call between the voice communication terminal 12(V) and the audio bridge 16. Notably, the Initiate Call message also provides the access code to the session server 44, which will subsequently provide the access code to the audio bridge 16 for gaining access to the conference call, as illustrated below.

In response to the Initiate Call message, the session server 44 may interact with the voice network 42 and the audio bridge 16 using third party call control techniques to establish a bearer path between the voice communication terminal 12(V) and the audio bridge 16 (steps 116 and 118). During or after the voice session is established, the session server 44 may provide the access code to the audio bridge 16 to identify and gain access to the appropriate conference call (step 120). Upon receipt of the access code and establishment of the voice session, the audio bridge 16 will connect the voice session to the conference call identified by the access code (step 122). At this point, the voice communication terminal 12(V) is connected to the conference call and User A is able to participate in the conference call. It is assumed that the other participants establish voice sessions for the conference call via their voice or composite communication terminals 12(V) or 12(C) in some fashion.

Once the voice session is established for the conference call, the session server 44 or audio bridge 16 may send a Call Success message back to the conference control function 36 to indicate that User A is successfully connected to the conference call via the voice communication terminal 12(V) (step 124). The conference control function 36 may then connect the data communication terminal 12(D) of User A into the media conference that is associated with the conference call via a web session using the access code that was previously provided or through another interaction with User A (step 126). The browser running on the data communication terminal 12(D) may periodically send Update Requests to the conference control function 36 to obtain updated pages to display in the browser interface 54 (step 128). The conference control function 36 will generate an appropriate media conference page (step 130) and provide the media conference page to the data communication terminal 12(D) (step 132), which will display the media conference page via the browser interface 54.

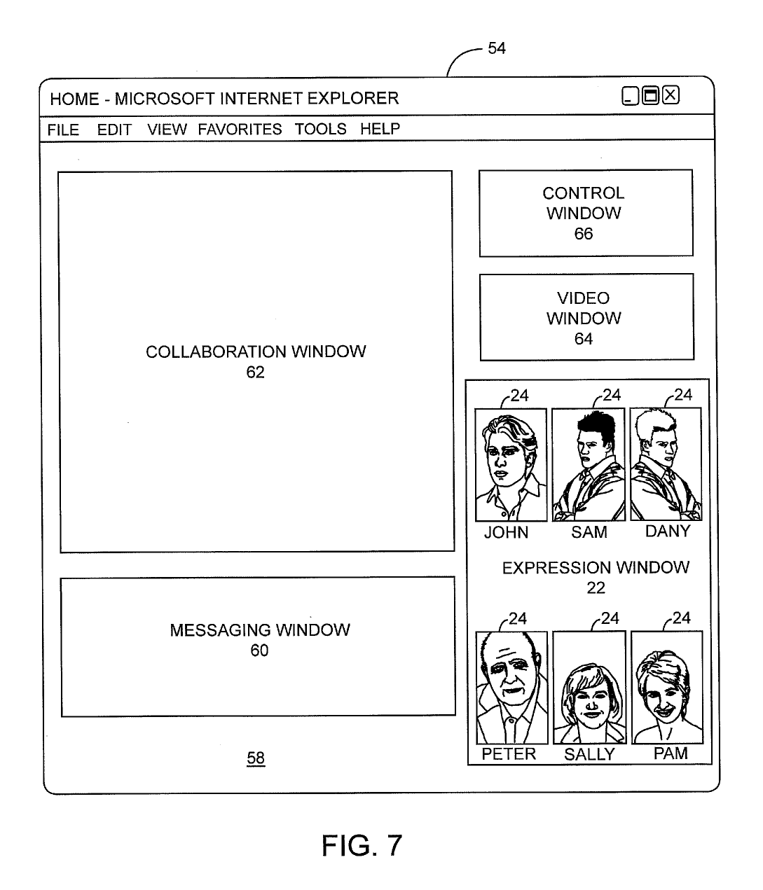

An exemplary conference media page 58 is illustrated in FIG. 7. The conference media page 58 may provide User A with multiple windows, each of which is capable of displaying various types of information that is directly or indirectly provided by the expression control function 14, video bridge 30, application sharing function 32, messaging function 34, or any combination thereof. As depicted, the conference media page 58 includes different windows for displaying information provided from the various functions. The conference media page 58 is illustrated as having a messaging window 60, a collaboration window 62, a video window 64, a control window 66, and an expression window 22. The expression window 22 may operate as described above, and will be described in further detail below. The messaging window 60 provides a window for the associated participant to generate and send instant messaging messages, email messages, or other proprietary messages to other participants via the messaging function 34. The browser may include or be associated with a corresponding messaging client, which is capable of interacting with the messaging function 34 directly or indirectly via the conference control function 36. The messaging window 60 also displays messages received from other participants under the control of the messaging client.

The collaboration window 62 provides a window for displaying and controlling applications being shared amongst the conference participants. Accordingly, the collaboration window 62 may display an image of an application interface and an associated document that is being shared by the conference participants in traditional application sharing fashion. The video window 64 may display the conference video of one or more of the conference participants and provided by the video bridge 30. In operation, the conference video may provide a mixed video of all or certain conference participants. A video client may be associated with or integrated in the browser to enable streaming video of the conference call to be displayed in the video window 64. The control window 66 may be provided for controlling the overall media conference and providing a control mechanism for allowing the participants to control the various media components as well as the audio component of the conference call. A control client associated with or integrated in the browser is capable of receiving input from the participant via the control window 66 or other windows provided in the conference media page 58 and providing appropriate instructions to the conference control function 36 or the other functions provided by the interactive conference system 28.

Expression-related information, such as participant objects 24, expression objects, such as emoticons 26 (not illustrated in FIG. 7), and the like may be provided in the expression window 22. Notably, the expression window 22 is an effective location to maintain participant objects 24 for identifying those participants in the conference call, identify the active speaker or speakers at any given time during the conference call, as well as displaying expression objects that are being asserted by a given participant, which will be described below. In this embodiment, assume the expression client is integrated with the browser or works in association with the browser that is providing the browser interface 54. As such, when information is received from the expression control function 14 directly or via the conference control function 36, the expression window 22 may be updated accordingly. Further, when a participant selects and asserts expression objects, the expression client will function to recognize the selection of the expression object and provide an appropriate expression request to the expression control function 14 directly or via the conference control function 36. The expression client may also have the capability of monitoring and controlling the persistence of expression objects based on information provided by the participant or the expression control function 14.

The following discussion provides an expression sharing example that takes place during the multimedia conference that was established above. The expression sharing will take place within the expression window 22, which will also keep track of participants in the conference call, as well as the active speaker or speakers at any given time in the conference call. Although these various functions are provided in association with the expression window 22, the sharing of expression information may take many forms, which vary significantly in complexity. For example, expression objects may simply be asserted from one participant to the other participants, wherein the expression object is displayed to a receiving participant in association with information identifying the participant who asserted the expression object. There is no need to continuously maintain a list of conference participants or identify active speakers with the present invention; however, the present embodiment illustrates a fuller featured representation of how the concepts of the present invention may be employed in a more sophisticated environment.

For the expression sharing example, the interaction between the expression control function 14 and the various expression clients is described. As indicated above, the messaging exchange between the expression control function 14 and the expression clients may be provided via the conference control function 36 and the expression clients or the browser that is associated with or includes the expression clients. For clarity, the information exchanged between and the functionality of the expression control function 14 and the expression clients of the various participants are described. Further, operation of the expression client alone or in association with the browser will facilitate updating and control of the expression window 22 based on actions of the associated participant, application of rules provided by the expression client, and instructions received from the expression control function 14.

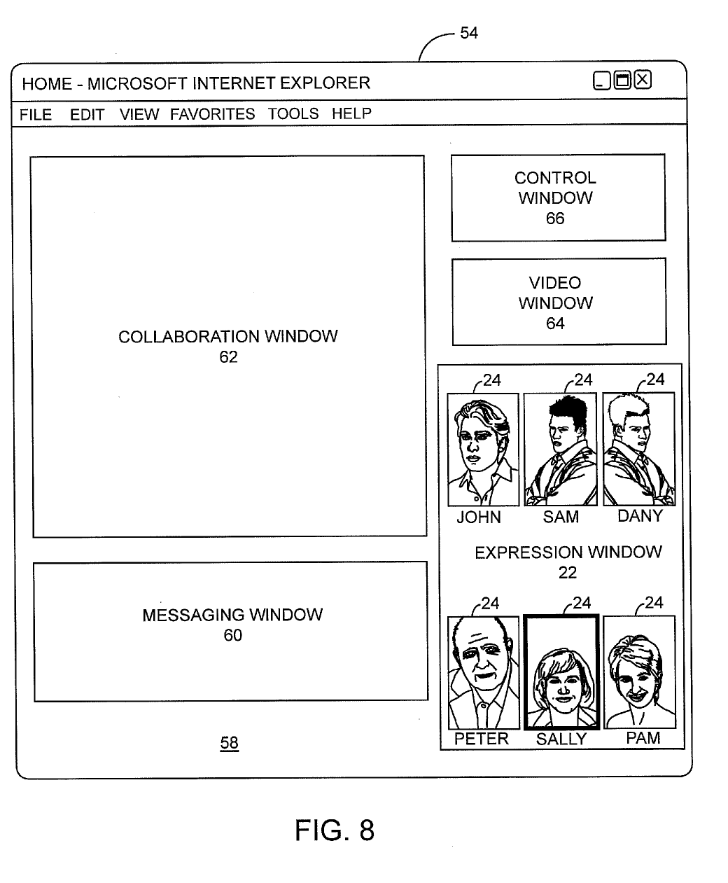

As illustrated in FIG. 7, assume the expression window 22 includes six participant objects 24, which represent the six participants that are currently participating in the conference call. Further assume that the conference control function 36 and the expression control function 14 have cooperated to identify the current participants, located participant objects 24, and provided sufficient information to the expression clients, such that the expression clients may populate the expression window 22 as illustrated. Notably, the participant objects 24 may also include or be associated with text, which includes the names of the various participants for ease of reference. Assume the names of the six participants are John, Sam, Dany, Peter, Sally, and Pam. Further assume that the conference media page 58 of FIG. 7 is at the beginning of the conference call and that no active speakers have been identified. Once an active speaker is identified based on information from the audio bridge 16, the conference control function 36 may instruct the expression client or other client that is handling active speaker notification to highlight or otherwise indicate that the speaker is actively speaking. In this example, assume that Sally is the first active speaker, and as such, will be highlighted as illustrated in FIG. 8. The highlighting takes the form of a frame being highlighted about the participant object 24 that is associated with Sally. In this embodiment, assume that all of the expression clients are updated accordingly, such that all of the participants can readily identify that it is Sally who is speaking based on information provided by the expression window 22.

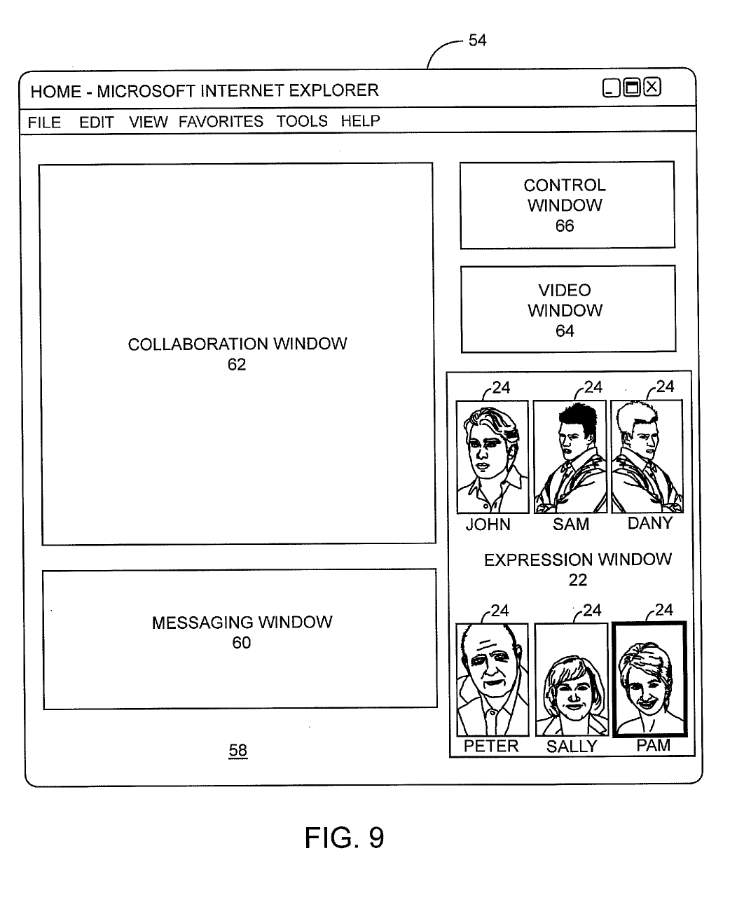

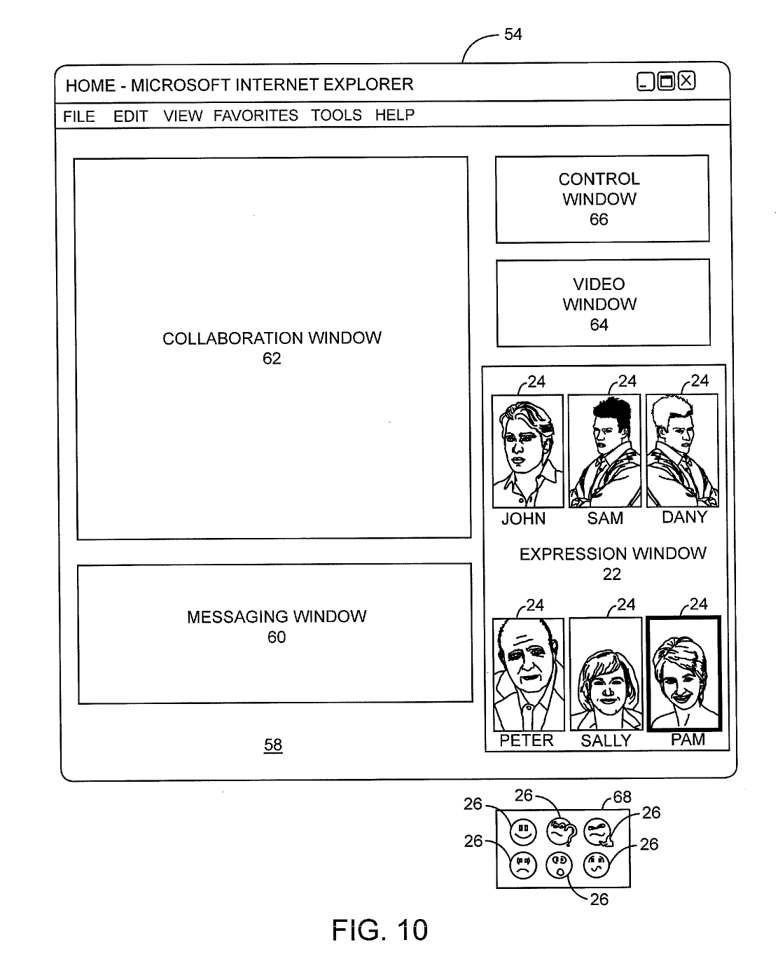

With reference to FIG. 9, when Pam becomes the active speaker, appropriate information is received from the audio bridge 16 by the conference control function 36, which may provide information to the expression client or other appropriate clients to facilitate an appropriate update of the expression window 22. The update will include removing the highlighting associated with Sally's participant object 24 and applying the highlighting to Pam's participant object 24 in the expression windows 22 for each of the participants. While Pam is currently the active speaker in the conference call, assume John has a question and desires to assert an expression object indicative of him having a question. With reference to FIG. 10, John may move his mouse over the expression window 22 and right-click, select an appropriate icon (not shown) in the control window 66 or the like, to initiate an expression sharing process. In this example, assume that John's initiation of the expression sharing process triggers the display of an expression object window 68, which is populated with expression objects in the form of emoticons 26 that are available to John for use in the conference call.

The expression objects represented in the expression object window 68 may have been dynamically downloaded in response to John logging into the media portion of the conference call, upon initiating the expression sharing process, or at any time before John logged into the conference call. When a set group of expression objects are available for all or most conference calls, the expression objects may be downloaded and maintained by the expression client. These expression objects may be used from one conference call to another. If the expression objects are selected by an organizer or other participant in the conference call or if they are based on the type of conference call or subject matter associated with the conference call, the selected expression objects that are available for the conference call may be downloaded to the expression client upon the respective participants accessing the media portion of the conference call. Further, the expression objects themselves may be maintained by the expression client, and information identifying the expression objects that are available during the conference call may be provided to the expression clients. As such, the expression clients may process the expression object information to identify the expression objects to provide in the expression object window 68 at any given time during a particular conference call.

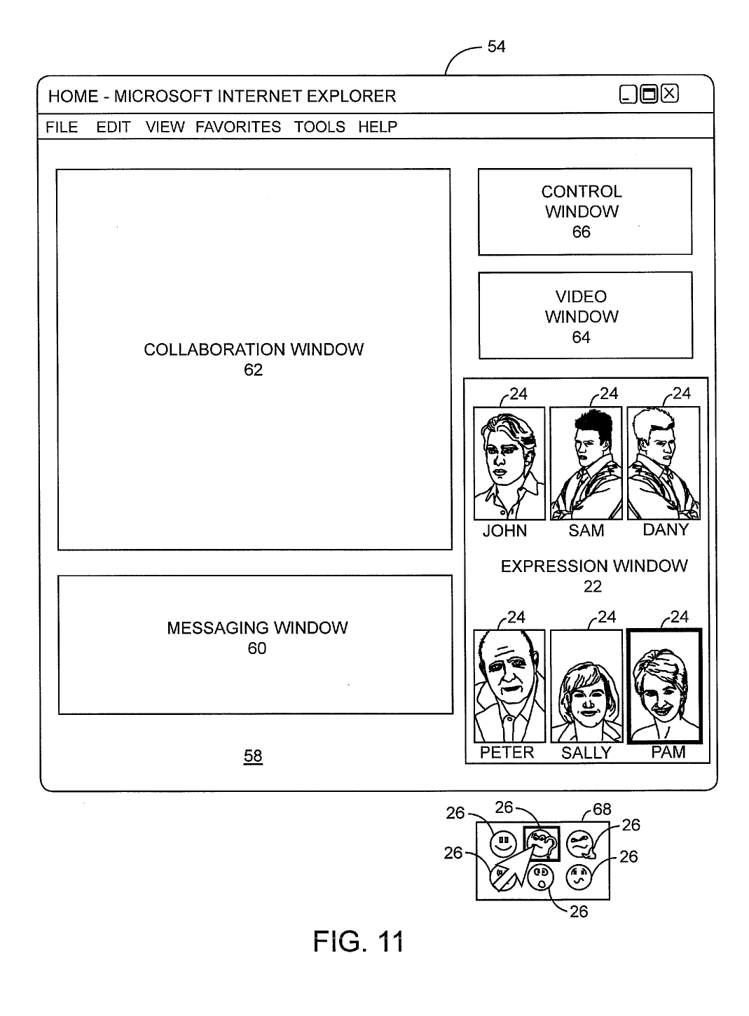

Regardless of how the expression client receives or determines the expression objects to provide in the expression object window 68, once the expression object window is presented to the participant that is wishing to assert an expression object, the participant may select an expression object that best represents the expression to be asserted from the expression objects provided in the expression object window 68. As illustrated in FIG. 11, the user may move their cursor over an emoticon 26 corresponding to a question and select the “question” emoticon 26. Although the current example illustrates manual selection of an expression object, biometric information may be used to detect an emotion and select a corresponding expression object based on the emotion. The biometric information may monitor pulse rate, body temperature, facial expressions, and the like. Facial recognition techniques could be used to analyze the facial expressions and assert emoticons based thereon. Similarly, appropriate monitors could be used to analyze pulse rate, respiration, body temperature, and the like to provide similar functions.

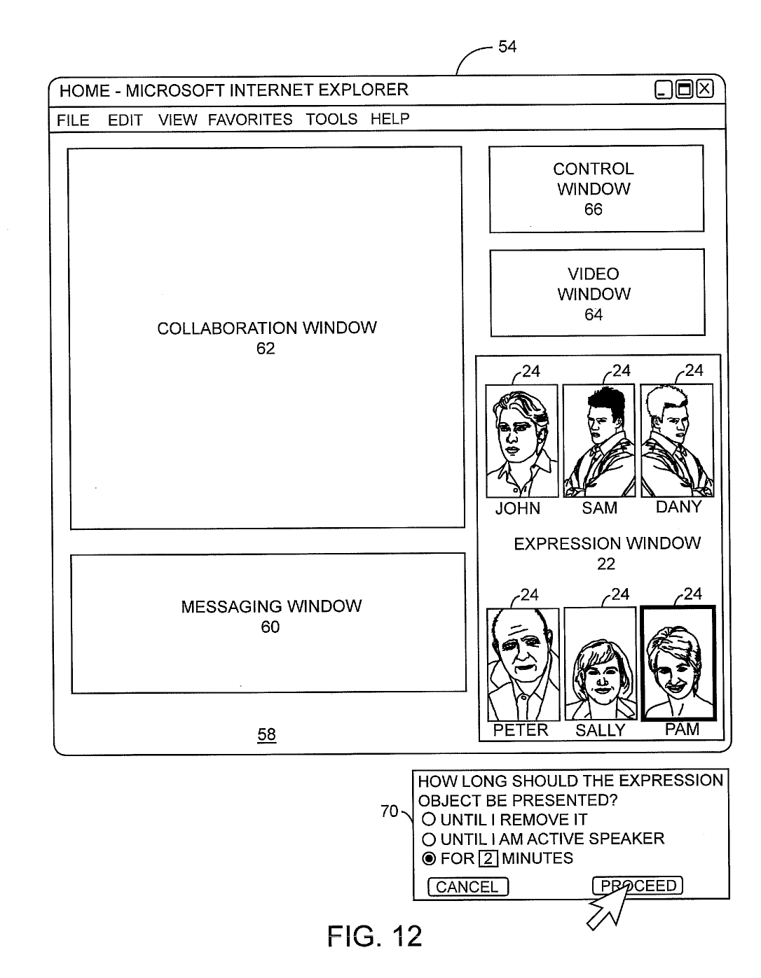

Once the question emoticon 26 is selected, the expression client may generate a persistence query and present the persistence query to the participant. The persistence query provides the participant with an opportunity to control how long it will be displayed to the other participants once the question emoticon 26 is provided to the other participants. As illustrated in FIG. 12, the persistence query may be provided in a separate persistence window 70. In this example, the persistence window 70 presents the question, “How long should the expression object be presented?” as well as three options from which the participant may select. The three options in this example include “until I remove it,” “until I am active speaker,” or “______ for minutes.” In this instance, assume that the participant selected the third option to have the question emoticon 26 presented to the other participants for two minutes. As such, the expression clients of the other participants, including the current participant (John) will remove the question emoticon 26 asserted by John once it has been displayed for two minutes. The persistence window 70 may also provide the participant with an opportunity to proceed with asserting the expression object or cancelling the assertion process.

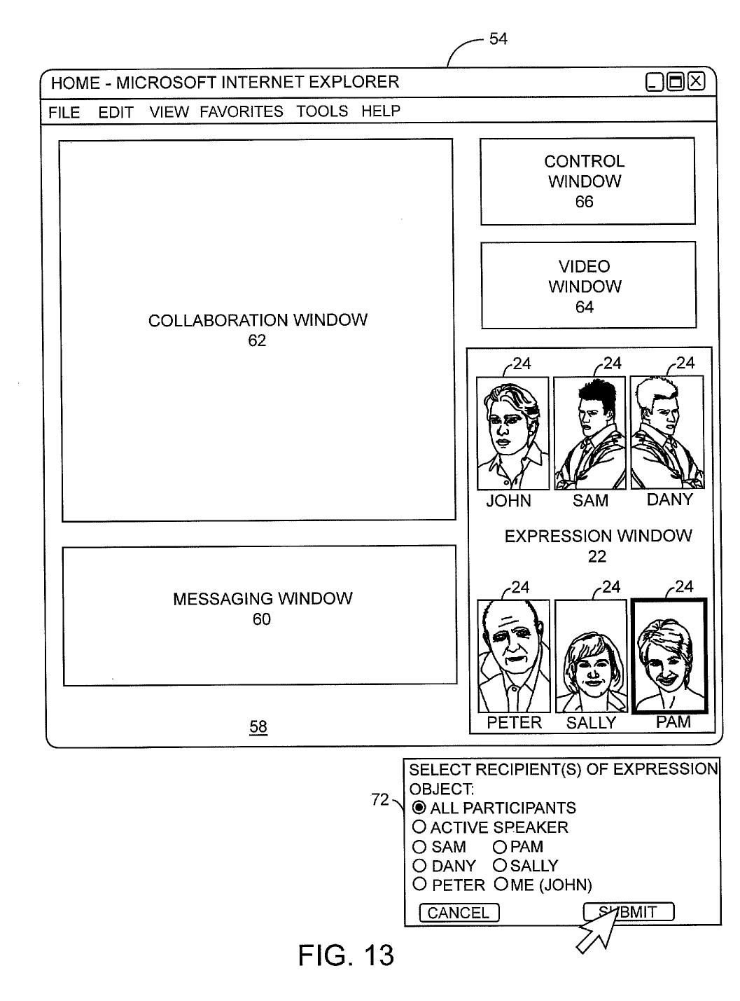

Assuming John proceeds with the assertion process, the expression client may next provide a request to identify the desired recipient(s) of the expression object. In certain embodiments, the participant asserting a particular expression object may select a particular participant or a sub-group of participants from the overall group of conference participants for delivery of the expression object. When such a feature is available, the expression client may present a recipient query to the participant asserting the expression object in the form of a recipient window 72, such as that illustrated in FIG. 13. In this example, the recipient window 72 provides an instruction to “Select recipient(s) of expression object:” to the participant asserting the expression object. Although the choices are configurable, the illustrated choices include, “all participants,” “active speaker,” and the individual participants Sam, Dany, Peter, Pam, Sally, and John. Since John is the participant asserting the expression object, he may elect not to have the expression object that he asserts appear in his expression window 22. However, assume John elects to have the expression object being asserted, the question emoticon 26, presented to all participants including himself. Notably, not all embodiments will involve persistence queries or recipient queries, as they are not necessary to practice the present invention.

Once the expression client has determined that John wishes to assert the question emoticon 26 to each of the conference participants for a period of two minutes, an appropriate expression request may be generated and sent to the expression control function 14. The expression request may identify the originator of the request, the selected expression object (question emoticon 26), recipient information if available, and persistence information if available. The expression control function 14 will process the expression request and deliver expression instructions to the affected expression clients. In this example, all of the expression clients are affected and expression instructions are sent to each of the expression clients. The expression instructions may include expression object information that identifies the expression object being asserted (question emoticon 26), the participant who is asserting the expression object, and perhaps persistence information that can be used by the expression client to control how long to display the expression object. When persistence information is provided to the expression client at this time, the expression client may control display and removal of the expression object from the expression window 22 based on the persistence information. Alternatively, the expression control function 14 may process the persistence information and provide subsequent instructions to the expression clients to clear or otherwise remove an expression object from being displayed after an appropriate time or upon occurrence of a designated event. The designated event may include the participant who asserted the expression object becoming the active speaker or a particular participant, including the asserting participant, taking an action to clear the expression object.

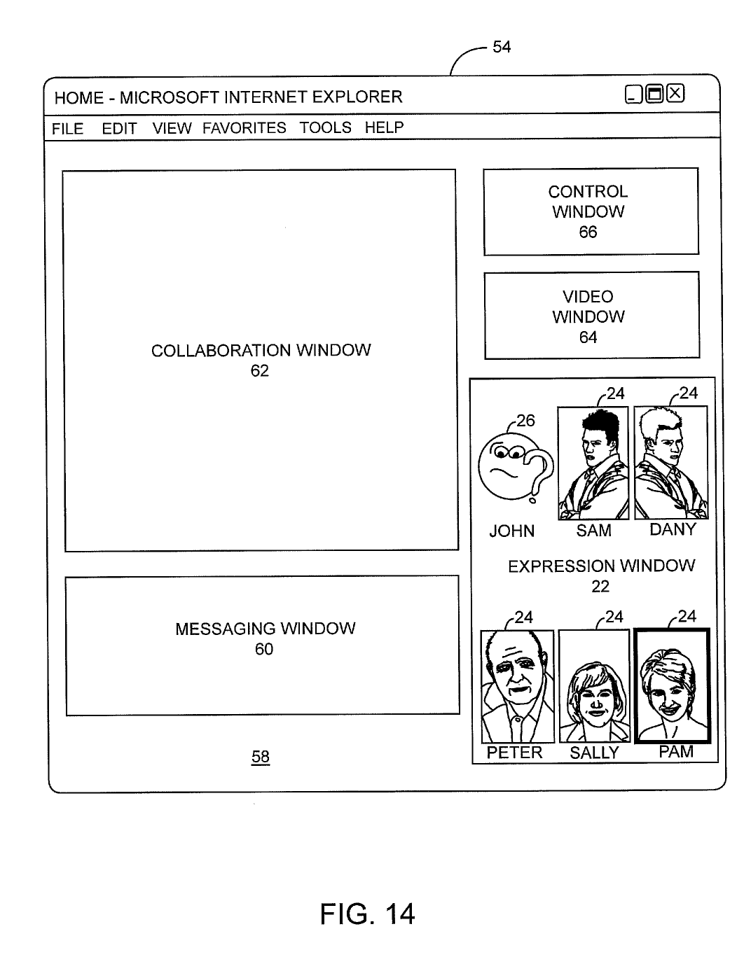

Continuing with the example, once an expression client has received the expression instructions from the expression control function 14 to display the question emoticon 26 in association with John's participant object 24, the expression client will display the question emoticon 26 in association with the participant object 24, as illustrated in FIG. 14. In this example, assume all or a part of the participant object 24 is removed and the expression emoticon 26 appears in association with text identifying John. As such, participants viewing their expression windows 22 may easily recognize that John has a question based on his assertion of the question emoticon 26.

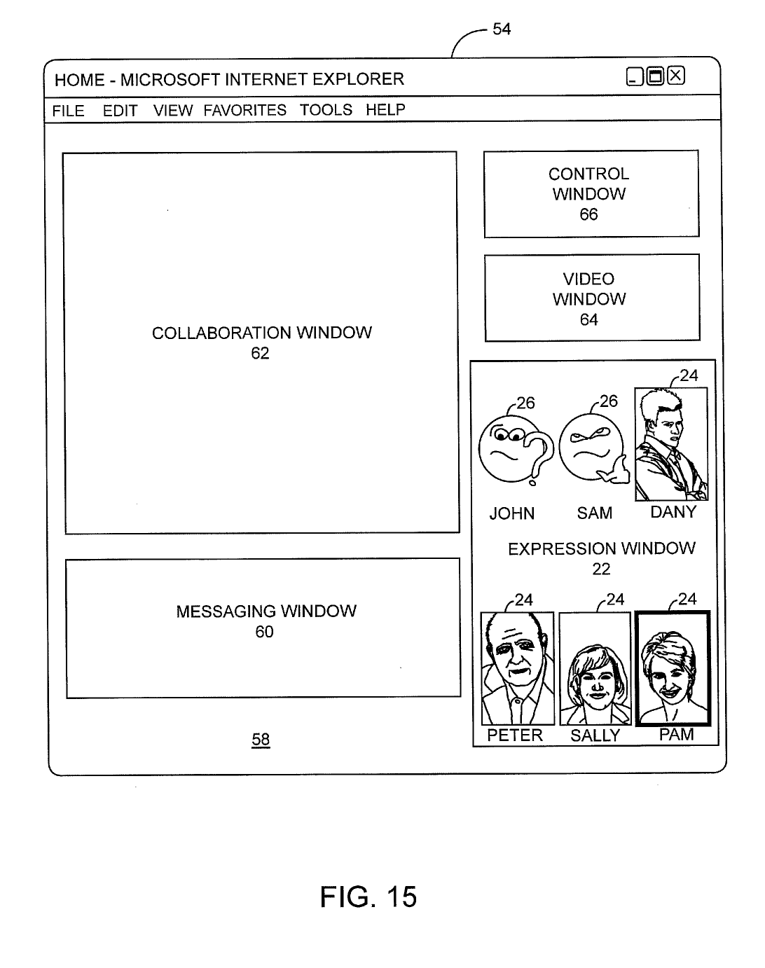

A given participant may assert multiple expression objects at any given time, and multiple participants may assert expression objects at any given time. In this example, assume that Sam becomes confused by what Pam is saying while the question emoticon 26, which was asserted by John, is still being displayed. Sam may employ a similar process to what John did to select an expression object, in this instance a confusion emoticon 26, along with any persistence or recipient information, and instruct his expression client to provide a corresponding expression request to the expression control function 14. The expression control function 14 will process the expression request and provide expression instructions to the expression clients of the appropriate participants. The expression instructions will cause the expression clients to display the confusion emoticon 26 in place of Sam's participant object 24, as illustrated in FIG. 15. Preferably, a portion of the participant object 24 or associated identification information is provided in association with the confusion emoticon 26 to allow a viewing participant to associate the confusion emoticon 26 with Sam. The illustrated expression window 22 may be provided by any of the expression clients of similarly affected participants.

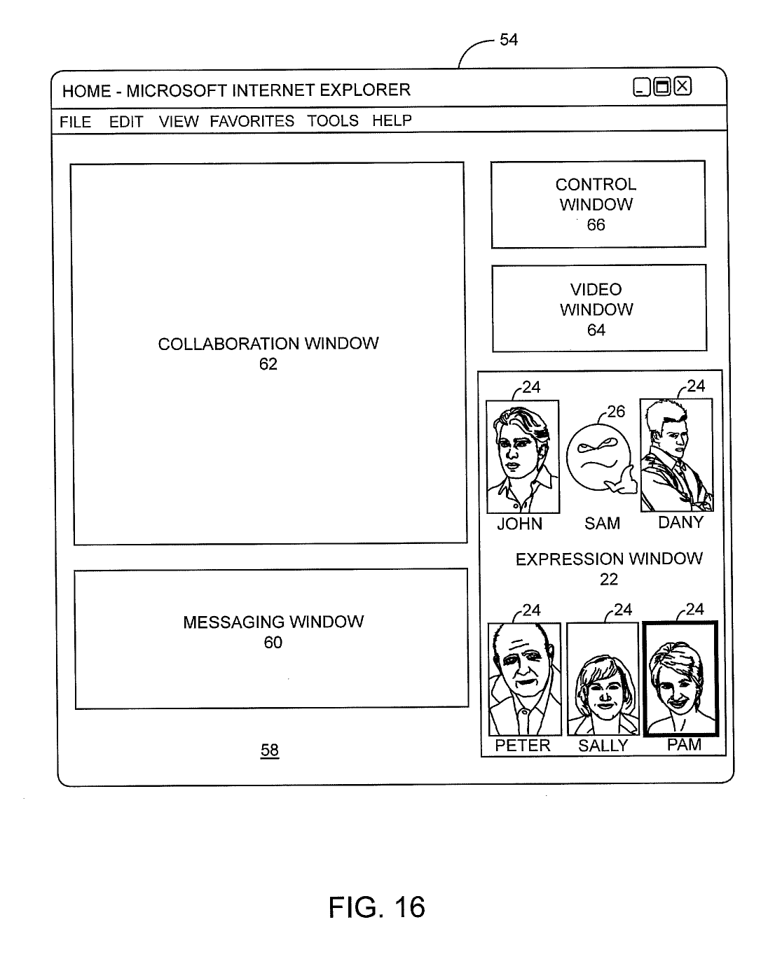

After the question emoticon 26 asserted by John has been displayed for two minutes, the expression clients that are displaying the question emoticon 26 may clear the question emoticon 26 from being displayed and replace it with John's participant object 24, as illustrated in FIG. 16. Alternatively, the expression control function 14 may recognize that the question emoticon 26 that was asserted by John has been displayed for two minutes, and provide appropriate expression instructions to the affected expression clients, which will respond to the expression instructions by clearing the question emoticon 26 and replacing it with the participant object 24. As such, the expression windows 22 of the affected expression clients have removed the question emoticon 26 that was asserted by John, but continue to display the confusion emoticon 26 asserted by Sam.

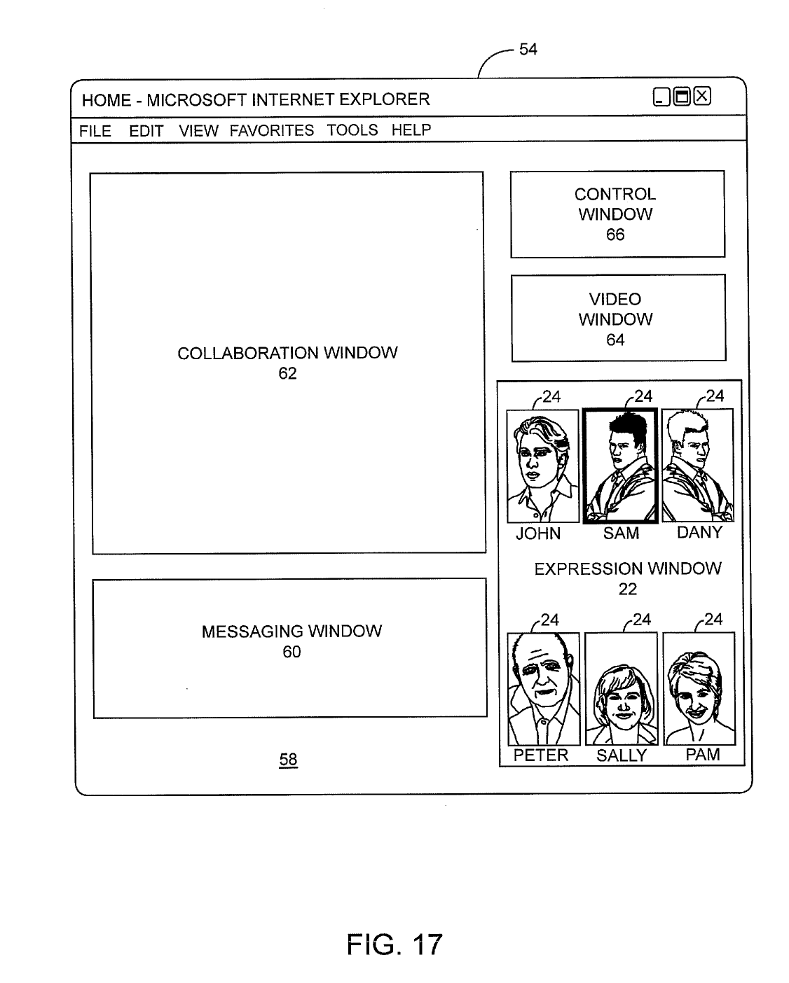

Assume that when Sam asserted the confusion emoticon, he selected persistence information that corresponds to having the confusion emoticon 26 displayed until Sam became the active speaker. Up until this point, assume that Pam continued to be the active speaker. When Sam becomes the active speaker, the audio bridge 16 can detect what participant is active in the audio portion of the conference call and provide appropriate instructions directly to the expression control function 14 or to the associated conference control function 36. In addition to instructing the expression client or appropriate client to provide indicia in the expression window 22 to indicate that Sam has now become the active speaker, the expression control function 14 will receive information indicating that Sam is now the active speaker. Accordingly, the expression window 22 is updated to indicate that Sam is the active speaker, and the expression control function 14 will recognize that the confusion emoticon 26 should be cleared now that Sam is the active speaker. The expression control function 14 may send expression instructions to the affected expression clients to either clear the confusion emoticon 26 that is associated with Sam or alert the expression clients that Sam is now the active speaker. The expression clients will either clear the confusion emoticon 26 based on a specific instruction to do so from the expression control function 14 or by recognizing that the confusion emoticon 26 should be removed once Sam becomes the active speaker, depending on the configuration of the expression client and how persistence information rules are applied. FIG. 17 illustrates an expression window 22 where the confusion emoticon 26 associated with Sam has been removed and the active speaker highlighting has been changed from Pam to Sam to identify Sam as the active speaker to other participants.

Throughout the above process, when the conference control function 36 is playing an integral role in effecting an interface between the various functions, including the video bridge 30, and the browser, expression client, or other clients running on the communication terminals 12, the conference control function 36 may interact with the various functions and coordinate delivery of information that is compatible with the browser or the clients that are running on the communication terminals 12. For example, information or content provided from the functions may be pushed to the browser for populating certain windows, or the conference control function 36 may effectively generate web pages that are either pushed to the browser or provided in response to update requests, such that the conference media page 58 is updated based on any changes that occur within any of the windows, including the expression window 22. Those skilled in the art will recognize numerous techniques for displaying the various conference related information in an individual or coordinated fashion, without departing from the concepts of the present invention. In particular, the functionality provided by the expression conference function 36 and the expression clients that are provided on the communication terminals 12 may be configured in different ways and implemented in standalone or integrated environments. Regardless of the configuration or environment, the expression sharing concepts provided herein remain applicable.

The following description provides a high-level overview of the operation of an exemplary audio bridge 16 configured according to one embodiment of the present invention. The present invention may be applied to audio bridges 16 of different configurations; however, the following illustrates the general operation of an audio bridge 16 as well as a technique for identifying an active speaker, or source, at any given time during a conference call. As described above, the expression control function 14 may use the source information to control the assertion or presentation of expression objects, the clearing of expression objects, and the like. Further, the expression control function 14 or an associated function may use the source information to provide active speaker information to appropriate clients running on the communication terminals 12, such that the active speaker may be identified to the various participants.

In general, the audio bridge 16 is used to facilitate the audio portion of a conference call between two or more conference participants who are in different locations. In operation, voice sessions from each of the participants are connected to the audio bridge 16. The audio levels of the incoming audio signals from the different voice sessions are monitored. One or more of the audio signals having the highest audio level are selected and provided to the participants as an output of the audio bridge 16. The audio signal with the highest audio level generally corresponds to the participant who is talking at any given time. If multiple participants are talking, audio signals for the participant or participants who are talking the loudest at any given time are selected.

The unselected audio signals are not provided by the audio bridge 16 to conference participants. As such, the participants are only provided the selected audio signal or signals and will not receive the unselected audio signals of the other participants. To avoid distracting the conference participants who are providing the selected audio signals, the selected audio signals are generally not provided back to the corresponding conference participants. In other words, the active participant in the conference call is not fed back their own audio signal. As the audio levels of the different audio signals change, different ones of the audio signals are selected throughout the conference call and provided to the conference participants as the output of the audio bridge 16.

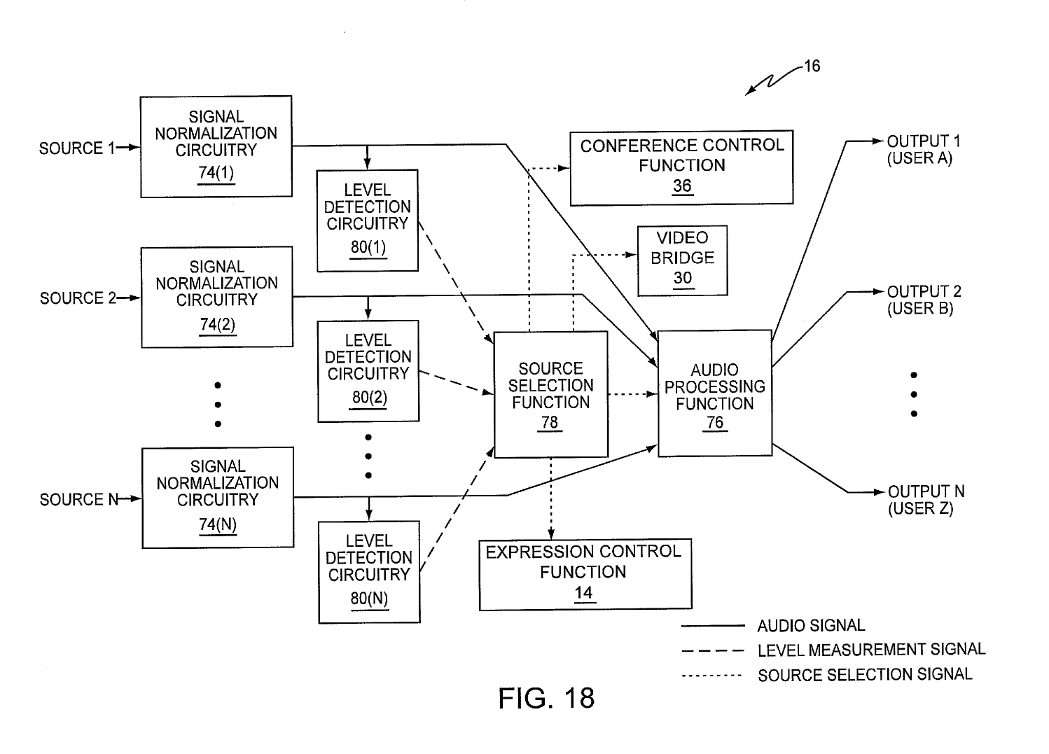

An exemplary architecture for an audio bridge 16 is provided in FIG. 18. Audio signals are received via source ports, SOURCE 1-N, and processed by signal normalization circuitry 74(1-N). The signal normalization circuitry 74(1-N) may operate on the various audio signals to provide a normalized signal level among the conference participants, such that the relative volume associated with each of the conference participants during the conference call is substantially normalized to a given level. The signal normalization circuitry 74(1-N) is optional, but normally employed in audio bridges 16. After normalization, the audio signals are sent to an audio processing function 76.

A source selection function 78 is used to select the source port, SOURCE 1-N, which is receiving the audio signals with the highest average level. The source selection function 78 provides a corresponding source selection signal to the audio processing function 76. The source selection signal identifies the source port, SOURCE 1-N, which is receiving the audio signals with the highest average level. These audio signals represent the selected audio signals to be output by the audio bridge 16. In response to the source selection signal, the audio processing function 76 will provide the selected audio signals from the selected source port, SOURCE 1-N from all of the output ports, OUTPUT 1-N, except for the output port associated with the selected source port. The audio signals from the unselected source ports, SOURCE 1-N are dropped, and therefore not presented to any of the output ports, OUTPUT 1-N, in traditional fashion.

Preferably, the source port, SOURCE 1-N, providing the audio signals having the greatest average magnitude is selected at any given time. The source selection function 78 will continuously monitor the relative average magnitudes of the audio signals at each of the source ports, SOURCES 1-N, and select appropriate source ports, SOURCE 1-N, throughout the conference call. As such, the source selection function 78 will select different ones of the source ports, SOURCE 1-N, throughout the conference call based on the participation of the participants.

The source selection function 78 may work in cooperation with level detection circuitry 80(1-N) to monitor the levels of audio signals being received from the different source ports, SOURCE 1-N. After normalization by the signal normalization circuitry 74(1-N), the audio signals from source ports, SOURCE 1-N are provided to the corresponding level detection circuitry 80(1-N). Each level detection circuitry 80(1-N) will process corresponding audio signals to generate a level measurement signal, which is presented to the source selection function 78. The level measurement signal corresponds to a relative average magnitude of the audio signals that are received from a given source port, SOURCE 1-N. The level detection circuitry 80(1-N) may employ different techniques to generate a corresponding level measurement signal. In one embodiment, a power level derived from a running average of given audio signals or an average power level of audio signals over a given period of time is generated and represents the level measurement signal, which is provided by the level detection circuitry 80 to the source selection function 78. The source selection function 78 will continuously monitor the level measurement signals from the various level detection circuitry 80(1-N) and select one of the source ports, SOURCE 1-N, as a selected source port based thereon. As noted, the source selection function 78 will then provide a source selection signal to identify the selected source port, SOURCE 1-N to the audio processing function 76, which will deliver the audio signals received at the selected source port, SOURCE 1-N, to the different output ports, OUTPUT 1-N that are associated with the unselected source ports, SOURCE 1-N.

The source selection function 78 may also provide the source selection signal to functions in the interactive conference system 28, such as the expression control function 14, conference control function 36, video bridge 30, or any combination thereof. The source selection signal may be used by the expression control function 14 to control assertion, presentation, clearing, and general control of expression objects that are being shared among the participants. The source selection information may be provided directly to the expression control function 14 or may be passed to the conference control function 36, which will interact with the expression control function 14 as necessary to operate according to the concepts of the present invention. Further, the video bridge 30 may use the source selection signal to identify a video screen that is associated with the active source, such that video of the active speaker is presented to the other conference participants. As the active source changes, the source selection signal changes, and these various functions may react accordingly.

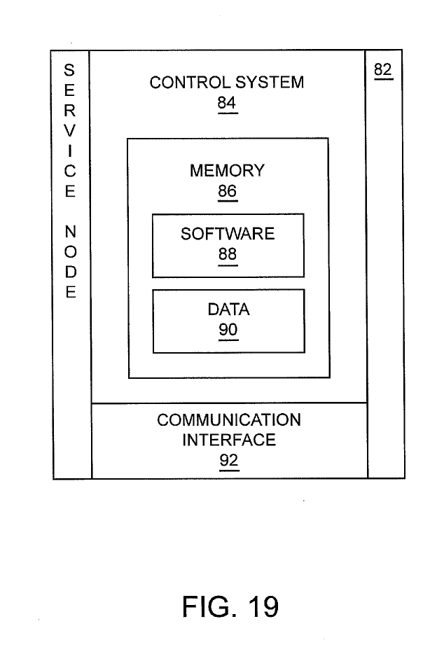

Turning now to FIG. 19, a block representation of a service node 82 that is capable of implementing one or more of the functions provided in the interactive conference system 28 is illustrated. The service node 82 will include a control system 84 having sufficient memory 86 for the requisite software 88 and data 90 to operate as described above. The control system 84 is associated with a communication interface 92 to facilitate communications with the various entities in the conference environment 10, as described above.

Those skilled in the art will recognize improvements and modifications to the preferred embodiments of the present invention. All such improvements and modifications are considered within the scope of the concepts disclosed herein and the claims that follow.

What is claimed is:

1. A method for sharing expressions among conference participants comprising:
receiving from a first expression client an expression request identifying expression information being asserted by a first participant to at least one other participant in a conference, the first conference participant associated with the first expression client and the at least one other participant associated with at least one other expression client;
determining persistence information bearing on how long the expression information should be presented to the at least one other participant;
instructing the at least one other expression client to present the expression information to the at least one other participant; and
controlling how long the at least one other expression client presents the expression information based on the persistence information.

2. The method of claim 1 wherein the persistence information is determined upon receiving the expression request.

3. The method of claim 1 wherein the persistence information dictates that the expression information be presented to the at least one other participant for a defined amount of time.

4. The method of claim 3 wherein the instructing the at least one other expression client to present the expression information and controlling how long the at least one other expression client presents the expression information comprises sending to the first expression client instructions to present the expression information for the defined amount of time.

5. The method of claim 1 wherein the persistence information dictates that the expression information be presented to the at least one other participant until a second participant of the conference provides a removal request to stop presenting the expression information to the at least one other participant, the method further comprising receiving the removal request from a second expression client associated with the second participant, and wherein controlling how long the at least one other expression client presents the expression information comprises instructing the at least one other expression client to stop presenting the expression information to the at least one other participant in response to the removal request.

6. The method of claim 5 wherein the second participant is a chairman of the conference.

7. The method of claim 5 wherein the at least one other expression client comprises a plurality of expression clients, which include the second expression client.

8. The method of claim 7 wherein the plurality of expression clients further includes the first expression client.

9. The method of claim 1 wherein the persistence information dictates that the expression information be presented to the at least one other participant until the first participant of the conference becomes an active speaker in an audio conference associated with the conference, the method further comprising receiving from an audio bridge that is supporting the conference, source information indicating the first participant is the active speaker, and wherein controlling how long the at least one other expression client presents the expression information comprises instructing the at least one other expression client to stop presenting the expression information to the at least one other participant in response to the first participant becoming the active speaker.

10. The method of claim 1 wherein the persistence information dictates that the expression information be presented to the at least one other participant until the first participant provides a removal request to stop presenting the expression information to the at least one other participant, the method further comprising receiving the removal request from the first expression client, and wherein controlling how long the at least one other expression client presents the expression information comprises instructing the at least one other expression client to stop presenting the expression information to the at least one other participant in response to the removal request.

11. The method of claim 1 wherein the persistence information is determined based on persistence criteria that is provided by the first participant and received in association with the expression request.

12. The method of claim 1 wherein the conference is associated with a plurality of expression clients including the at least one other expression client and the first expression client, and select ones of the plurality of expression clients are not instructed to present the expression information to the at least one other participant.

13. The method of claim 1 wherein the conference is associated with a plurality of expression clients including the at least one other expression client and the first expression client, the first expression client provides recipient information identifying select ones of the plurality of expression clients to instruct to present the expression information, and only the select ones of the plurality of expression clients are instructed to present the expression information.

14. The method of claim 1 wherein the expression information is a first expression object selected from a first group of expression objects.

15. The method of claim 14 wherein the first expression client allows the first participant to select the first expression object from the first group of expression objects and identify the first expression object in the expression request.

16. The method of claim 15 further comprising:
selecting expression objects from an overall group to define the first group of expression objects as well as a second group of expression objects, wherein the first group of expression objects is different from the second group of expression objects by at least one expression object;
instructing the first expression client to limit selection and assertion of expression objects by the first participant to those provided in the first group of expression objects for the conference; and
instructing the first expression client to limit selection and assertion of expression objects by the first participant to those provided in the second group of expression objects for another conference, wherein different groups of expression objects may be used for different conferences.

17. The method of claim 16 further comprising selecting the first group of expression objects for the conference.

18. The method of claim 17 wherein the first group of expression objects is selected by the first participant.

19. The method of claim 18 wherein the first participant is an organizer of the conference.

20. The method of claim 17 wherein the first group of expression objects is selected by another participant in the conference.

21. The method of claim 17 wherein the first group of expression objects is selected based on one of a group consisting of a conference participant, a conference organizer, a conference chairperson, and a purpose of conference.

22. The method of claim 14 wherein the first expression object is an emoticon.

23. The method of claim 14 wherein the first expression object is one of a group consisting of a symbol, an icon, an image, a static graphic, an animated graphic, and a video segment.

24. The method of claim 1 wherein the expression indicia corresponds to a non-verbal communication cue.

25. The method of claim 1 further comprising providing an audio bridge for voice sessions associated with the first participant and the at least one other participant.

26. The method of claim 1 wherein the expression information is presented to the at least one other participant in association with first identification information associated with the first participant.

27. The method of claim 1 further comprising:
identifying a plurality of participants in the conference including the first participant and the at least one other participant; and
sending information identifying the plurality of participants to the first expression client and the at least one other expression client.

28. The method of claim 1 further comprising facilitating exchange of expression information between expression clients of various participants in the conference and controlling presentation and removal of the expression information by the expression clients in a dynamic fashion throughout the conference.

29. A method for sharing expressions among conference participants comprising:
selecting expression objects from an overall group to define a first group of expression objects as well as a second group of expression objects, wherein the first group of expression objects is different from the second group of expression objects by at least one expression object;
instructing a first expression client associated with a first participant of a conference to limit selection and assertion of expression objects by the first participant from those provided in the first group of expression objects for the conference;
receiving from the first expression client an expression request identifying an expression object being asserted by the first participant to at least one other participant in the conference, the at least one other participant associated with at least one other expression client;
instructing the at least one other expression client to present the expression information to the at least one other participant; and
instructing the first expression client to limit selection and assertion of expression objects by the first participant from those provided in the second group of expression objects for another conference, wherein different groups of expression objects may be used for different conferences.
